(19) United States
(12) Patent Application Publication
(10) Pub. No.: US 2002/0099620 A1
(43) Pub. Date: Jul. 25, 2002

(54) Unmanned retail shop system and method of purchasing goods

(75) Inventors: Akimasa Ohta, Tokyo (JP); Hisaharu Sakamoto, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/050,949

(22) Filed: Jan. 22, 2002

(30) Foreign Application Priority Data
Jan. 19, 2001 (JP) 2001-012069

(51) Int. Cl. G06F 17/60

(52) U.S. Cl. 705/26; 705/28; 705/39

(57) ABSTRACT

In an unmanned retail shop system, an user side information terminal, a retail shop side information terminal, and a settlement agency side information terminal are connected with each other through a network. The user side information terminal has not only means for selecting goods to be purchased and for transmitting information of the purchased goods to the retail shop side information terminal but also means for transmitting information of settlement account thereto. The retail shop side information terminal has a container for containing goods. The retail shop side information terminal further has means for transmitting, to the settlement agency side information terminal, not only information of request of drawing the money charged for the purchased goods but also information of request of transferring the money into the retail shop's account. The settlement agency side information terminal has not only means for making a secret number for opening the key of the container in which the purchased goods are contained but also means for transmitting the secret number both to the user side information terminal and to the retail shop side information terminal.

### BACKGROUND OF THE INVENTION

The present invention relates to an unmanned retail shop system in which a purchaser can receive goods in an unmanned warehouse after the purchaser purchased the goods.

In a conventional retail shop system, it is necessary for a plurality of traders to intervene therein while a manufacturer delivers manufactured goods to a retail shop. The more traders intervene therein, the more intermediate margins are generated. As a result, a purchaser price of the goods is raised more.

As means for solving the above problem, some proposals are made about an unmanned shop system. For example, an unmanned shop apparatus is exemplified in Japanese Patent Publication No.2503192. Further, exemplified in examined Japanese Patent Publication No.Hei7-11806 is an electronic order and delivery receiving system having an apparatus including a locker which is capable of controlling lock and unlock of the locker and in which the ordered goods are delivered and received. Furthermore, exemplified in unexamined Japanese Patent Publication No.Hei10-162065 is a delivery management system having an agency provided with a delivery box.

However, it is difficult to conduct a shop of twenty-four business hours. It is therefore hard to achieve an unmanned shop. On the other hand, another proposal is also made about a system in which a purchaser receives his goods at a convenience store of twenty-four business hours, and the like. However, in a case that a purchaser receives his goods at such a convenience store, and the like, goods capable of being handled are restricted.

In the proposed systems mentioned above, the purchaser who has purchased goods receives the goods at a convenience store, or by the use of delivery. In the interim, a purchaser sometimes would not like another persons to see the goods that he has purchased. However, the purchaser cannot prevent the goods from being seen by the another persons, when the purchaser receives the goods at a convenience store or by the use of delivery. In addition, in the method that the purchaser receives the goods by the use of delivery, the purchaser cannot receive the goods unless he stays at home.

Further, in the proposed systems mentioned above, a wholesale dealer delivers goods to a convenience store, and the like. It is therefore hard to deliver the goods quickly from a manufacturer to a consumer. As a result, intermediate margins are generated. Accordingly, expenses charged to a purchaser become large. Under the circumstances, desired is a retail shop system in which a purchaser can receive goods in an unmanned warehouse after the purchaser purchased the goods.

### SUMMARY OF THE INVENTION

It is therefore an object of the present invention to provide an unmanned retail shop system in which a purchaser can receive goods in an unmanned warehouse after the purchaser purchased the goods.

Other objects of the present invention will become clear as the description proceeds.

According to an aspect of the present invention, there is provided an unmanned retail shop system comprising: an user side information terminal provided in the user side; a retail shop side information terminal provided in the retail shop side; and a settlement agency side information terminal provided in the settlement agency side; the user side information terminal, the retail shop side information terminal and the settlement agency side information terminal being connected with each other through a network; the user side information terminal including: selected goods information transmitting means for selecting goods to be perchased and transmitting information of the purchased goods to the retail shop side information terminal; and settlement account information transmitting means for transmitting information of settlement account for paying money charged for the purchased goods to the retail shop side information terminal; the retail shop side information terminal including: a container for containing goods; receiving means for receiving the information of the purchased goods and the information of settlement account both transmitted from the user side information terminal; and transmitting means for transmitting information of request of drawing the money charged for the purchased goods and information of request of transferring the money charged for the purchased goods into the retail shop's account, the transmitting means transmitting both of the information to the settlement agency side information terminal; the settlement agency side information terminal including: receiving means for receiving both of the information of request of drawing the money charged for the purchased goods and the information of request of transferring the money charged for the purchased goods into the retail shop's account; making means for making a secret number for opening a key of the container in which the purchased goods are contained; and transmitting means for transmitting the secret number both to the user side information terminal and to the retail shop side information terminal.

With the constitution mentioned above, in the unmanned retail shop system according to the aspect of the present invention, an user who wants to purchase goods can receive purchased goods in an unmanned container for containing goods after the user purchased the goods. Further, in the unmanned retail shop system according to the aspect of the present invention, the user can go to receive the purchased goods at the user's own convenience. In other words, it is not necessary for a conveyer to deliver the purchased goods to the user's home. This can avoid troublesome that the purchased goods need to be delivered again in a case the user is not at home.

Furthermore, the user receives the purchased goods in the unmanned container for containing goods in the unmanned retail shop system according to the aspect of the present invention. The user can prevent the purchased goods from being seen by another persons, when the user would not like the another persons to see the purchased goods.

Moreover, in the unmanned retail shop system according to the aspect of the present invention, the goods are directly delivered to the retail shop s unmanned container for containing goods. The intermediate traders can be reduced, so that the purchased goods can be delivered quickly. In addition, cost, such as personnel expenditure, or the like can be reduced, so that the intermediate margins can be decreased.

On the other hand, in the unmanned retail shop system, the settlement agency side information terminal may further comprise drawing and transferring means for drawing the money charged for the purchased goods from the settlement account transmitted from the user side information terminal and for transferring the money charged for the purchased goods into the retail shop s account.

With this constitution, the money charged for the purchased goods can be drawn from the settlement account of the user who purchases the goods and transferred into the retail shop's account automatically. Accordingly, automatic settlement becomes available.

On the other hand, the unmanned retail shop system may further comprise a stock maker side information terminal which is provided in the stock maker side and which is connected with the unmanned retail shop system through a network, wherein the stock maker side information terminal may comprise transmitting means for transmitting stocked goods information to the retail shop side information terminal.

With this constitution, the stocked goods information is transmitted to the retail shop side information terminal. As a result, the user can know available goods in the retail shop by getting access to a homepage established by the retail shop.

According to another aspect of the present invention, there is also provided a method of purchasing goods which is for use in an unmanned retail shop system between an user side information terminal provided in the user side, a retail shop side information terminal provided in the retail shop side having a container for containing goods, and a settlement agency side information terminal provided in the settlement agency side, the method comprising the steps of: the user, operating the user side information terminal to access the retail shop side information terminal, selecting goods to be perchased, and transmitting not only information of the purchased goods but also information of settlement account for paying money charged for the purchased goods to the retail shop side information terminal; the retail shop side information terminal, upon receiving the information of the purchased goods and the information of settlement account both transmitted from the user side information terminal, transmitting not only information of request of drawing the money charged for the purchased goods but also information of request of transferring the money charged for the purchased goods into the retail shop's account to the settlement agency side information terminal; the settlement agency side information terminal, upon receiving the information of request of drawing the money charged for the purchased goods and the information of request of transferring the money charged for the purchased goods into the retail shop's account, drawing the money charged for the purchased goods from the settlement account to transfer the money charged for the purchased goods into the retail shop's account; the settlement agency side information terminal, further making a secret number for opening a key of the container in which the purchased goods are contained, and transmitting the secret number both to the user side information terminal and to the retail shop side information terminal; and upon transferring the money charged for the purchased goods into the retail shop s account, the retail shop, containing the purchased goods purchased by the user in the container.

With the constitution mentioned above, in the method of purchasing goods according to the another aspect of the present invention, an user who wants to purchase goods can receive purchased goods in an unmanned container for containing goods after the user purchased the goods. Further, in the method of purchasing goods according to the another aspect of the present invention, the user can go to receive the purchased goods at the user s own convenience. In other words, it is not necessary for a conveyer to deliver the purchased goods to the user's home. This can avoid troublesome that the purchased goods need to be delivered again in a case the user is not at home.

Furthermore, the user receives the purchased goods in the unmanned container for containing goods in the method of purchasing goods according to the another aspect of the present invention. The user can prevent the purchased goods from being seen by another persons, when the user would not like the another persons to see the purchased goods.

Moreover, in the method of purchasing goods according to the another aspect of the present invention, the goods are directly delivered to the retail shop s unmanned container for containing goods. The intermediate traders can be reduced, so that the purchased goods can be delivered quickly. In addition, cost, such as personnel expenditure, or the like can be reduced, so that the intermediate margins can be decreased.

On the other hand, in the method of purchasing goods according to the another aspect of the present invention, the unmanned retail shop system may further include a stock maker side information terminal which is provided in the stock maker side and which is connected with the unmanned retail shop system through a network, the method may further comprise the step of the stock maker side information terminal, transmitting stocked goods information to the retail shop side information terminal.

With this constitution, the stocked goods information is transmitted to the retail shop side information terminal. As a result, the user can know available goods in the retail shop by getting access to a homepage established by the retail shop.

According to yet another aspect of the present invention, there is also provided a computer program for carrying out the method of purchasing goods which is for use in an unmanned retail shop system between an user side information terminal provided in the user side, a retail shop side information terminal provided in the retail shop side having a container for containing goods, and a settlement agency side information terminal provided in the settlement agency side, the computer program comprising the processings of: the user, operating the user side information terminal to access the retail shop side information terminal, selecting goods to be perchased, and transmitting not only information of the purchased goods but also information of settlement account for paying money charged for the purchased goods to the retail shop side information terminal; the retail shop side information terminal, upon receiving the information of the purchased goods and the information of settlement account both transmitted from the user side information terminal, transmitting not only information of request of drawing the money charged for the purchased goods but also information of request of transferring the money charged for the purchased goods into the retail shop's account to the settlement agency side information terminal; the settlement agency side information terminal, upon receiving the information of request of drawing the money charged for the purchased goods and the information of request of transferring the money charged for the purchased goods into the retail shop's account, drawing the money charged for the purchased goods from the settlement account to transfer the money charged for the purchased goods into the retail shop's account; the settlement agency side information terminal, further making a secret number for opening a key of the container in which the purchased goods are contained, and transmitting the secret number both to the user side information terminal and to the retail shop side information terminal; and upon transferring the money charged for the purchased goods into the retail shop's account, the retail shop, containing the purchased goods purchased by the user in the container.

With the constitution mentioned above, in the computer program according to yet another aspect of the present invention, it becomes possible to conduct the method that an user who wants to purchase goods can receive purchased goods in an unmanned container for containing goods after the user purchased the goods. Further, in the method of purchasing goods carried out by the computer program according to yet another aspect of the present invention, the user can go to receive the purchased goods at the user's own convenience. In other words, it is not necessary for a conveyer to deliver the purchased goods to the user's home. This can avoid troublesome that the purchased goods need to be delivered again in a case the user is not at home.

Furthermore, in the method of purchasing goods carried out by the computer program according to yet another aspect of the present invention, the user receives the purchased goods in the unmanned container for containing goods. The user can prevent the purchased goods from being seen by another persons, when the user would not like the another persons to see the purchased goods.

Moreover, in the method of purchasing goods carried out by the computer program according to yet another aspect of the present invention, the goods are directly delivered to the retail shop's unmanned container for containing goods. The intermediate traders can be reduced, so that the purchased goods can be delivered quickly. In addition, cost, such as personnel expenditure, or the like can be reduced, so that the intermediate margins can be decreased.

On the other hand, in the computer program according to yet another aspect of the present invention, the unmanned retail shop system may further include a stock maker side information terminal which is provided in the stock maker side and which is connected with the unmanned retail shop system through a network, the computer program may further comprise the processing of the stock maker side information terminal, transmitting stocked goods information to the retail shop side information terminal.

With this constitution, the stocked goods information is transmitted to the retail shop side information terminal. As a result, the user can know available goods in the retail shop by getting access to a homepage established by the retail shop.

### BRIEF DESCRIPTION OF THE DRAWINGS

FIG. 1 is a schematic view for showing an unmanned retail shop system according to a preferred embodiment of the present invention; and

FIG. 2 is a schematic view for explaining a method of purchasing goods according to a preferred embodiment of the present invention.

### DETAILED DESCRIPTION OF THE PREFERRED EMBODIMENT

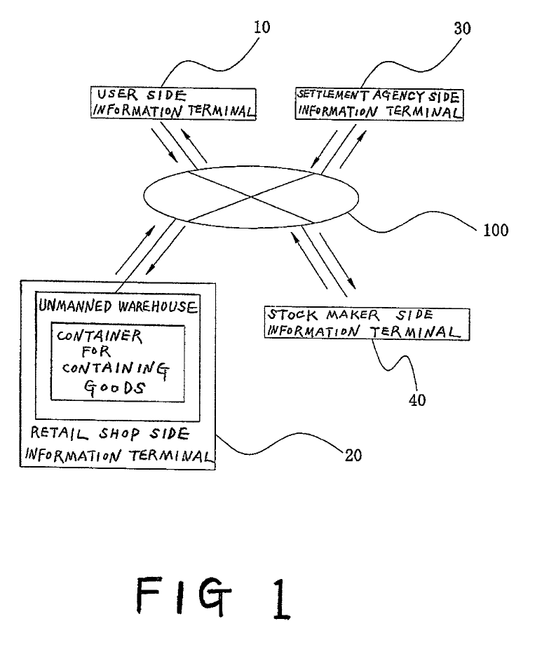

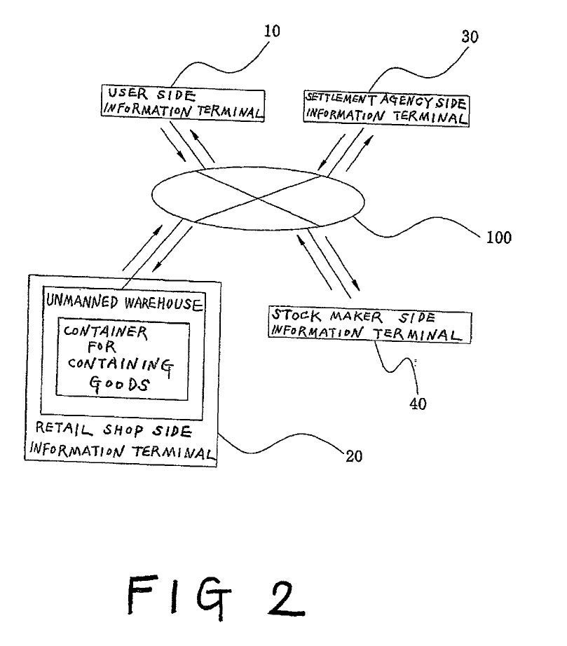

Referring now to FIGS. 1 and 2, description will proceed to an unmanned retail shop system according to a preferred embodiment of the present invention. FIG. 1 is a schematic view for showing the unmanned retail shop system according to the preferred embodiment of the present invention.

As illustrated in FIG. 1, the unmanned retail shop system according to the preferred embodiment of the present invention comprises an user side information terminal 10 provided in the user side, a retail shop side information terminal 20 provided in the retail shop side, a settlement agency side information terminal 30 provided in the settlement agency side, and a stock maker side information terminal 40 provided in the stock maker side. The user side information terminal 10, the retail shop side information terminal 20, the settlement agency side information terminal 30, and the stock maker side information terminal 40 are connected with each other through a network 100.

Herein, it is preferable that the network 100 is, for example, such a network 100 as using an Internet, and the like. It is enough that the network 100 is such a wire or wireless network in which information is transferred between the user side information terminal 10, the retail shop side information terminal 20, the settlement agency side information terminal 30, and the stock maker side information terminal 40.

Further, the user side information terminal 10 is such an information terminal as used by an user who purchases goods. The user side information terminal 10 has means for getting access to an WWW (World Wide Web) browser, or the like capable of access to a homepage through the network 100. Concretely, the user side information terminal 10 is an information terminal, such as a personal computer, a portable telephone, a mobile computer, and the like capable of being connected with the network 100, such as the Internet, or the like.

The user side information terminal 10 has means by which an user selects goods to be purchased and transmits information of the purchased goods to the retail shop side information terminal 20. By the use of the user side information terminal 10, the user can conduct the selection of the goods to be purchased by getting access to a homepage established by the retail shop and clicking the goods published in the homepage by a mouth, and the like.

In addition, the user side information terminal 10 has means for transmitting information of settlement account for paying money charged for the purchased goods to the retail shop side information terminal 20. The user can input and transmit the information of the settlement account by operating a keyboard provided in the user side information terminal 10.

The retail shop side information terminal 20 is such an information terminal as provided in the side of a retail shop selling goods. The retail shop side information terminal 20 has means for getting access to an WWW (World Wide Web) browser, or the like capable of access to a homepage through the network 100. Concretely, the retail shop side information terminal 20 is an information terminal, such as a personal computer, a portable telephone, a mobile computer, and the like capable of being connected with the network 100, such as the Internet, or the like. Further, the retail shop side information terminal 20 may be composed of an information processing device, such as a work station server, and the like.

The retail shop side information terminal 20 has a container for containing goods, that is, an unmanned warehouse. The container for containing goods is such a place in which the purchased goods purchased by an user are contained. The container for containing goods is provided with a key. The key provided in the container is adjusted to be opened by inputting a secret number as will later be described.

In addition, the retail shop side information terminal 20 has means for receiving the information of the purchased goods and the information of the settlement account both transmitted from the user side information terminal 10.

Further, the retail shop side information terminal 20 has means for transmitting, to the settlement agency side information terminal 30, not only information of request of drawing the money charged for the purchased goods but also information of request of transferring the money charged for the purchased goods into the retail shop's account. Since the retail shop side information terminal 20 has such the means, automatic settlement becomes available. Accordingly, convenience for both an user and a retail shop is so improved.

The settlement agency side information terminal 30 is such an information terminal as provided in the side of a settlement agency. The settlement agency side information terminal 30 has means for getting access to an WWW (World Wide Web) browser, or the like capable of access to a homepage through the network 100. Concretely, the settlement agency side information terminal 30 is an information terminal, such as a personal computer, a portable telephone, a mobile computer, and the like capable of being connected with the network 100, such as the Internet, or the like. Further, the settlement agency side information terminal 30 may be composed of an information processing device, such as a work station server, and the like.

Further, the settlement agency side information terminal 30 has means for receiving not only the information of request of drawing the money charged for the purchased goods but also the information of request of transferring the money charged for the purchased goods into the retail shop's account, both of which are transmitted from the retail shop side information terminal 20. Moreover, the settlement agency side information terminal 30 has not only means for making a secret number for opening the key of the container in which the purchased goods are contained but also means for transmitting the secret number both to the user side information terminal 10 and to the retail shop side information terminal 20.

In the unmanned retail shop system according to the preferred embodiment of the present invention, the settlement agency side information terminal 30 makes the secret number for opening the key of the container in which the purchased goods are contained. Thereafter, the secret number is transmitted both to the user side information terminal 10 and to the retail shop side information terminal 20. An user who purchased goods can get the purchased goods out of the container for containing goods, that is, an unmanned warehouse by inputting the secret number received by the user side information terminal 10. In other words, it is not necessary for a conveyer to deliver the purchased goods to the user s home. As a result, the user can prevent the purchased goods from being seen by another persons, when the user would not like the another persons to see the purchased goods.

Besides, the retail shop side information terminal 20 has means for judging whether or not the secret number inputted by the user to get the purchased goods out of the container is identical with the one transmitted from the settlement agency side information terminal 30. The means are also for preventing the key from being opened in a case that the secret number inputted by the user to get the purchased goods out of the container is not identical with the one transmitted from the settlement agency side information terminal 30. Accordingly, another persons who do not know the secret number cannot get any goods out of the container. As a result, the user can prevent the another persons from getting the purchased goods out of the container.

In addition, the settlement agency side information terminal 30 has means for drawing the money charged for the purchased goods from the settlement account transmitted from the user side information terminal 10 and for transferring the money charged for the purchased goods into the retail shop s account The settlement agency side information terminal 30 has such the means, so that automatic settlement becomes available.

On the other hand, in the unmanned retail shop system illustrated in FIG. 1, the stock maker side information terminal 40 provided in the stock maker side is connected to the unmanned retail shop system through the network 100.

The stock maker side information terminal 40 is such an information terminal as provided in the side of a stock maker. The stock maker side information terminal 40 has means for getting access to an WWW (World Wide Web) browser, or the like capable of access to a homepage through the network 100. Concretely, the stock maker side information terminal 40 is an information terminal, such as a personal computer, a portable telephone, a mobile computer, and the like capable of being connected with the network 100, such as the Internet, or the like. Further, the stock maker side information terminal 40 may be composed of an information processing device, such as a work station server, and the like.

Further, the stock maker side information terminal 40 has means for transmitting stocked goods information to the retail shop side information terminal 20. The stock maker side information terminal 40 has such the means, so that the stocked goods information are transmitted to the retail shop side information terminal 20. As a result, the user can know available goods in the retail shop by getting access to a homepage established by the retail shop. Accordingly, by the use of the user side information terminal 10, the user can conduct the selection of the goods to be purchased by getting access to a homepage established by the retail shop and clicking the goods published in the homepage by a mouth, and the like.

Next, referring to FIG. 2, description will proceed to a method of purchasing goods according to a preferred embodiment of the present invention. The method of purchasing goods can be conducted by using the unmanned retail shop system according to the preferred embodiment of the present invention.

The method of purchasing goods according to the preferred embodiment of the present invention is conducted using the unmanned retail shop system between an user side information terminal provided in the user side, a retail shop side information terminal provided in the retail shop side having a container for containing goods, and a settlement agency side information terminal provided in the settlement agency side. The method of purchasing goods according to the preferred embodiment comprises the steps of: the user, operating the user side information terminal to access the retail shop side information terminal, selecting goods to be perchased, and transmitting not only information of the purchased goods but also information of settlement account for paying money charged for the purchased goods to the retail shop side information terminal; the retail shop side information terminal, upon receiving the information of the purchased goods and the information of settlement account both transmitted from the user side information terminal, transmitting not only information of request of drawing the money charged for the purchased goods but also information of request of transferring the money charged for the purchased goods into the retail shop's account to the settlement agency side information terminal; the settlement agency side information terminal, upon receiving the information of request of drawing the money charged for the purchased goods and the information of request of transferring the money charged for the purchased goods into the retail shop's account, drawing the money charged for the purchased goods from the settlement account to transfer the money charged for the purchased goods into the retail shop's account; the settlement agency side information terminal, further making a secret number for opening a key of the container in which the purchased goods are contained, and transmitting the secret number both to the user side information terminal and to the retail shop side information terminal; and upon transferring the money charged for the purchased goods into the retail shop's account, the retail shop, containing the purchased goods purchased by the user in the container.

FIG. 2 is a schematic view for explaining the method of purchasing goods according to the preferred embodiment of the present invention.

At first, the retail shop operates the retail shop side information terminal 20 to get access to the stock maker side information terminal 40 (Step A1). Upon the access to the stock maker side information terminal 40 by the retail shop side information terminal 20, the stock maker side information terminal 40 transmits the stocked goods information to the retail shop side information terminal 20. The retail shop side information terminal 20 then receives the stocked goods information (Step A2). Upon receiving the stocked goods information by the retail shop side information terminal 20, the retail shop renews information of the homepage owned by the retail shop.

On the other hand, the stock maker delivers the goods to the container for containing goods, that is, an unmanned warehouse owned by the retail shop (Step A3). Besides, delivery of the goods may be carried out after the user has reserved purchase of the goods. Further, delivery of the goods may be carried out after the money charged for the purchased goods is transferred into the retail shop's account.

The user operates the user side information terminal 10 to get access to the retail shop side information terminal 20 (Step A4). The user thereby reviews the homepage established by the retail shop (Step A5). The user then reviews a list of the goods in the homepage established by the retail shop. Among the goods, the user selects the goods to be purchased. The selection of the goods can be carried out by clicking the desirable goods using, for example, a mouth, and the like. Alternatively, the selection of the goods can be carried out by inputting a name, a code number, and the like of the desirable goods using a keyboard.

Next, after the selection of the goods is completed, the user transmits not only information of the purchased goods but also information of settlement account for paying money charged for the purchased goods to the retail shop side information terminal 20 (Step A6). Upon receiving not only the information of the purchased goods but also the information of the settlement account for paying money charged for the purchased goods by the retail shop side information terminal 20, the retail shop transmits not only information of request of drawing the money charged for the purchased goods but also information of request of transferring the money charged for the purchased goods into the retail shop's account to the settlement agency side information terminal 30 (Step A7).

Although not illustrated in FIG. 2, upon receiving the information of request of drawing the money charged for the purchased goods and the information of request of transferring the money charged for the purchased goods into the retail shop's account, the settlement agency side information terminal 30 draws the money charged for the purchased goods from the settlement account to transfer the money charged for the purchased goods into the retail shop's account. Thereafter, the settlement agency side information terminal 30 makes a secret number for opening a key of the container in which the purchased goods are contained. The settlement agency side information terminal 30 then transmits the secret number both to the user side information terminal 10 and to the retail shop side information terminal 20 (Step A8).

Although not illustrated in FIG. 2, upon transferring the money charged for the purchased goods into the retail shop's account, the retail shop contains the purchased goods purchased by the user in the container owned by the retail shop. The container in which the purchased goods are contained is adjusted not to open the key, unless the secret number made by the settlement agency side information terminal 30 is inputted thereto.

Then, upon receiving the secret number, the user opens the key of the container by inputting the secret number to the container (Step A9). The user gets the purchased goods out of the container.

Besides, in the above embodiment, settlement is completed at the time that the user reserved the purchase of the goods. However, the settlement may be completed at the other time.

Next, description proceeds to a computer program for carrying out the method of purchasing goods according to the preferred embodiment of the present invention. The program controls operations of a computer to carry out the method of purchasing goods mentioned above. The computer controlled by the program conducts the method of purchasing goods mentioned above upon receiving commands of the program.

As described above, the unmanned retail shop system according to the preferred embodiment of the present invention is such a system that the user can receive the purchased goods in the unmanned container for containing goods.

Further, the method of purchasing goods according to the preferred embodiment of the present invention is such a method that the user can receive the purchased goods in the unmanned container for containing goods.

Furthermore, the computer program according to the preferred embodiment of the present invention is such a program for enabling a computer to carry out the method of purchasing goods according to the preferred embodiment of the present invention.

What is claimed is:

1. An unmanned retail shop system comprising:
an user side information terminal provided in the user side;
a retail shop side information terminal provided in the retail shop side; and
a settlement agency side information terminal provided in the settlement agency side;
said user side information terminal, said retail shop side information terminal and said settlement agency side information terminal being connected with each other through a network;
said user side information terminal including:
selected goods information transmitting means for selecting goods to be purchased and transmitting information of the purchased goods to said retail shop side information terminal; and
settlement account information transmitting means for transmitting information of settlement account for paying money charged for the purchased goods to said retail shop side information terminal;
said retail shop side information terminal including:
a container for containing goods;
receiving means for receiving said information of the purchased goods and said information of settlement account both transmitted from said user side information terminal; and
transmitting means for transmitting information of request of drawing said money charged for the purchased goods and information of request of transferring said money charged for the purchased goods into the retail shop's account, said transmitting means transmitting both of said information to said settlement agency side information terminal;
said settlement agency side information terminal including:
receiving means for receiving both of said information of request of drawing said money charged for the purchased goods and said information of request of transferring said money charged for the purchased goods into the retail shop's account;
making means for making a secret number for opening a key of said container in which the purchased goods are contained; and
transmitting means for transmitting said secret number both to said user side information terminal and to said retail shop side information terminal.

2. An unmanned retail shop system as claimed in claim 1, wherein said settlement agency side information terminal further comprises drawing and transferring means for drawing said money charged for the purchased goods from said settlement account transmitted from said user side information terminal and for transferring said money charged for the purchased goods into said retail shop's account.

3. An unmanned retail shop system as claimed in claim 1, further comprising a stock maker side information terminal which is provided in the stock maker side and which is connected with said unmanned retail shop system through a network, wherein said stock maker side information terminal comprises transmitting means for transmitting stocked goods information to said retail shop side information terminal.

4. An unmanned retail shop system as claimed in claim 2, further comprising a stock maker side information terminal which is provided in the stock maker side and which is connected with said unmanned retail shop system through a network, wherein said stock maker side information terminal comprises transmitting means for transmitting stocked goods information to said retail shop side information terminal.

5. A method of purchasing goods which is for use in an unmanned retail shop system between an user side information terminal provided in the user side, a retail shop side information terminal provided in the retail shop side having a container for containing goods, and a settlement agency side information terminal provided in the settlement agency side, said method comprising the steps of:
said user, operating said user side information terminal to access said retail shop side information terminal, selecting goods to be purchased, and transmitting not only information of the purchased goods but also information of settlement account for paying money charged for the purchased goods to said retail shop side information terminal;
said retail shop side information terminal, upon receiving said information of the purchased goods and said information of settlement account both transmitted from said user side information terminal, transmitting not only information of request of drawing said money charged for the purchased goods but also information of request of transferring said money charged for the purchased goods into the retail shop's account to said settlement agency side information terminal;
said settlement agency side information terminal, upon receiving said information of request of drawing said money charged for the purchased goods and said information of request of transferring said money charged for the purchased goods into the retail shop s account, drawing said money charged for the purchased goods from said settlement account to transfer the money charged for the purchased goods into said retail shop's account;
said settlement agency side information terminal, further making a secret number for opening a key of said container in which the purchased goods are contained, and transmitting said secret number both to said user side information terminal and to said retail shop side information terminal; and
upon transferring said money charged for the purchased goods into the retail shop's account, said retail shop, containing the purchased goods purchased by said user in said container.

6. A method as claimed in claim 5, said unmanned retail shop system further including a stock maker side information terminal which is provided in the stock maker side and which is connected with said unmanned retail shop system through a network, said method further comprising the step of said stock maker side information terminal, transmitting stocked goods information to said retail shop side information terminal.

7. A computer program for carrying out the method of purchasing goods which is for use in an unmanned retail shop system between an user side information terminal provided in the user side, a retail shop side information terminal provided in the retail shop side having a container for containing goods, and a settlement agency side information terminal provided in the settlement agency side, said computer program comprising the processing of:
said user, operating said user side information terminal to access said retail shop side information terminal, selecting goods to be purchased, and transmitting not only information of the purchased goods but also information of settlement account for paying money charged for the purchased goods to said retail shop side information terminal;
said retail shop side information terminal, upon receiving said information of the purchased goods and said information of settlement account both transmitted from said user side information terminal, transmitting not only information of request of drawing said money charged for the purchased goods but also information of request of transferring said money charged for the purchased goods into the retail shop's account to said settlement agency side information terminal;
said settlement agency side information terminal, upon receiving said information of request of drawing said money charged for the purchased goods and said information of request of transferring said money charged for the purchased goods into the retail shop's account, drawing said money charged for the purchased goods from said settlement account to transfer the money charged for the purchased goods into said retail shop's account;
said settlement agency side information terminal, further making a secret number for opening a key of said container in which the purchased goods are contained, and transmitting said secret number both to said user side information terminal and to said retail shop side information terminal; and
upon transferring said money charged for the purchased goods into the retail shop's account, said retail shop, containing the purchased goods purchased by said user in said container.

8. A computer program as claimed in claim 7, said unmanned retail shop system further including a stock maker side information terminal which is provided in the stock maker side and which is connected with said unmanned retail shop system through a network, said computer program further comprising the processing of said stock maker side information terminal, transmitting stocked goods information to said retail shop side information terminal.
